(19) United States
(12) Patent Application Publication
(10) Pub. No.: US 2004/0250333 A1
(43) Pub. Date: Dec. 16, 2004

(54) Multi-purpose dishwashing glove

(76) Inventor: Mark Friedman, New York, NY (US)

Correspondence Address: MARVIN N. GORDON, SUITE 2015, 630 FIFTH AVE, NEW YORK, NY, 10111, US

(21) Appl. No.: 09/800,992

(22) Filed: Mar. 8, 2001

(51) Int. Cl. G06F 17/60

(52) U.S. Cl. 2/159

(57) ABSTRACT

A dishwashing glove includes a sponge material secured to the palm region of the glove and an abrasive material secured to the upper ends of the fingers of the glove.

### BACKGROUND OF THE INVENTION

The present invention relates to an improved, more efficient dishwashing glove.

Although many if not most of the homes in this country are equipped with dishwashing machines, the washing of dishes by hand is still commonly done. In those homes that do not include a dishwasher, the entire dishwashing process is performed by hand; in those homes that do include a dishwasher, the initial washing operation is also still often performed by hand usually to remove the more difficult to remove food particles, before the prewashed dish is placed in the dishwasher. On occasion, the item being washed, such as a large pot or frying pan, may be too large to conveniently fit in the washing machine, and thus must be completely washed by hand.

Since many dishwashing soaps include caustic chemicals that may irritate and chafe the user's hands, it is by now a common practice for the individual who is washing dishes to wear a glove, typically one made of rubber, to protect his or her hands from the dishwashing soap while he or she is washing dishes. It is also common and also often necessary for the person who is washing dishes to employ additional implements to facilitate and speed up the dishwashing procedure. One commonly used dishwashing implement is a sponge that absorbs a relatively large amount of the dishwashing soap; another is an abrasive material, such as a pad of steel wool, which is used to remove food particles that cling to the dish, pot or pan being washed.

The typical homekeeper must thus purchase and maintain separate supplies of rubber gloves, soap sponges and abrasive pads and must keep them readily available near the sink so that they are all readily accessible when he or she is washing dishes. However, it is often the case that the homeowner runs out of a usable sponge or abrasive pad and learns of this fact while he or she has need for its use while washing dishes. On other occasions, it is difficult to find a usable sponge or abrasive pad, and on yet other occasions the handling of a sponge or abrasive pad by an individual wearing soapy or wet dishwashing gloves is cumbersome and frustrating to the user. It may also be difficult for the individual to readily reach some areas with a hand-held steel wool pad. There thus exists a need for a dishwashing implement that is more convenient in use and which does away with the above-described difficulties associated with the use of a conventional dishwashing glove.

### SUMMARY OF THE DISCLOSURE

The dishwashing glove of the invention includes an otherwise conventional glove made of a suitable flexible and protective material such as rubber. A sponge or spongelike material capable of absorbing dishwashing soap is secured on its lower surface to the palm portion of the glove. In addition, an abrasive material such as steel wool or abrasive plastic is secured to the upper ends of the finger sections of the glove and preferably to the thumb portion as well. The dishwashing glove of the invention provides the user with the functions of protection for the user's hand against the adverse effects of the dishwashing fluids while additionally allowing the user, by use of the sponge attachment, to more conveniently apply and remove soap from a dish and, by the use of the abrasive material, to remove hard-to-remove particles from the dish or pan all with a single, unitary glove.

### DESCRIPTION OF THE DRAWINGS

The present invention will be more fully appreciated and understood upon consideration of the following detailed description, with reference to the appended drawing in which:

FIG. 1 is a front elevation view of a dishwashing glove in accordance with an embodiment of the invention; and

FIG. 2 is a cross-section taken along the direction of the arrows 2-2 in FIG. 1.

### DETAILED DESCRIPTION OF AN EMBODIMENT OF THE INVENTION

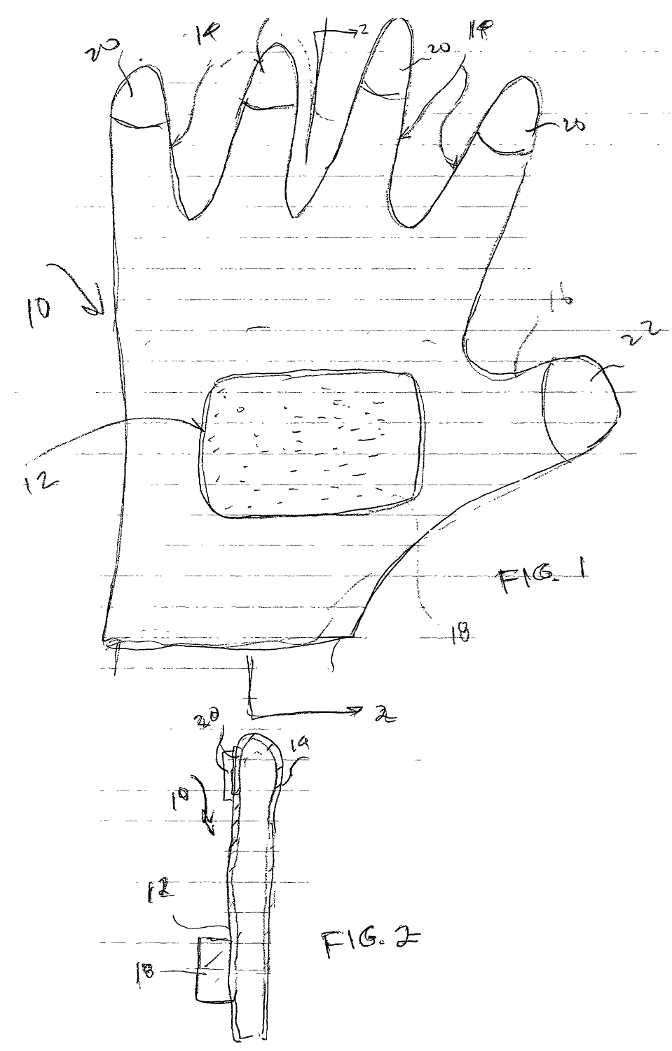

Referring to the figures, there is shown in FIG. 1 a dishwashing glove generally designated 10 in accordance with an embodiment of the invention. As is otherwise conventional, glove 10 is made of a suitable elastic material, such as rubber or latex that is resistant to the harsh chemicals used in many detergents currently used to wash dishes. As is also otherwise conventional, glove 10 includes a palm region 12, four hollow finger sections 14, and a hollow thumb section 16. When in use the user inserts his or her fingers into finger sections 14 and the thumb into thumb section 16.

In accordance with the present invention, a portion of a sponge-like material 18 is secured, preferably detachably, to the palm region 12, such as by a Velcro fastener or the like. Sponge material 18, which may be a natural sponge or a synthetic sponge material of the type commonly sold separately in supermarkets, may also, if desired, be permanently secured to the palm region 12 as by a suitable water-resistant adhesive. In addition, an abrasive material 20, such as steel wool or an abrasive plastic, is secured to the upper joint of each of finger sections 14 as by a suitable water-resistant adhesive. An additional abrasive portion 22 may be, as shown, affixed to the upper joint portion of the thumb section 16.

When used to wash a load of dishes, the user may wear a glove 10 on one or both of his or her hands. In the former case, the user would wear a conventional dishwashing glove on his or her other hand. In use, the sponge material 18 would absorb a quantity of soapy water that could then be used to remove food or other material from a dish or pan held in the user's other hand. The sponge material 18 may also be later used to remove much of the soapy water from the dish or pan. The abrasive materials 20,22 are used to remove difficult to remove particles such as particles that stick to a pan. Since the abrasive materials 20,22 are carried by the ends of the finger sections of the glove, which are relatively narrow, they can be used to remove particles from hard-to-reach locations of, say a frying pan, which could not be easily reached by a conventional steel wool pad. In a glove of this type, in which the sponge-like material can be removed from the glove 10, a new, fresh sponge material may be attached to the palm region 12 to replace the previously used sponge material, which has been removed after it loses its absorbency or is otherwise not suited for further use.

It will be apparent that the dishwashing glove of the invention provides greater convenience in washing dishes and the like without the need to search for and maintain adequate supplies of separate sponges and abrasive materials. It will also be appreciated that modifications may be made to the disclosed embodiment of the invention, such as affixing the abrasive material to less than all fingers and thumb sections, without necessarily departing from the spirit and scope of the invention.

What is claimed is:

1. A glove for use in washing dishes or the like, said glove comprising a palm region and a plurality of finger-receiving sections extending therefrom, a water-absorbent material affixed to said palm region, and an abrasive material affixed to the upper end of at least one of said finger-receiving sections.

2. The glove of claim 1, in which one of said abrasive materials is respectively affixed to the upper end of each of said finger-receiving sections.

3. The glove of claim 2, further comprising a thumb-receiving section, an additional one of said abrasive materials being affixed to the upper end of said thumb-receiving section.

4. The glove of claim 1, in which said water-absorbent material is a sponge-like material.

5. The glove of claim 4, in which said sponge-like material is removably attached to the palm region of the glove.

6. The glove of claim 1, in which said sponge-like material is removably attached to the palm region of the glove.

7. The glove of claim 1, in which said water-absorbent material is a sponge.
